(19) United States
(12) Patent Application Publication
(10) Pub. No.: US 2014/0258053 A1
(43) Pub. Date: Sep. 11, 2014

(54) SYSTEM AND METHOD FOR ACCOUNTING OF FINANCIAL INSTRUMENTS

(71) Applicants: Ekkehard Lange, Karlsruhe (DE); Matthias Schauer, Zuerich (AT)

(72) Inventors: Ekkehard Lange, Karlsruhe (DE); Matthias Schauer, Zuerich (AT)

(73) Assignee: SAP AG, Walldorf (DE)

(21) Appl. No.: 13/788,754

(22) Filed: Mar. 7, 2013

(51) Int. Cl. G06Q 40/00

(52) U.S. Cl. CPC G06Q 40/10
USPC 705/30

(57) ABSTRACT

Embodiments of the present disclosure provide systems and methods for accounting of financial instruments. The accounting method for financial instrument may include receiving financial instrument data and classifying the financial instrument data into position components. The financial instrument data may be classified into position components based on three distinctions. The first distinction may determine whether the position component is operational or analytical. The second distinction may determine whether the position component is dependent or independent on a value-date. The third distinction may determine whether the position component is event-driven, deterministic or stochastic. The financial instrument accounting may be performed using the financial instrument data classified into the position components.

### BACKGROUND

Financial instruments (e.g., stocks, floating securities or fixed-interest bonds etc.) may include tradable assets that provide a financial asset for one party and a financial liability or equity instrument for another party. Both parties are interested in accounting of the financial instruments to recognize the value of the financial instruments on their balance sheets. Proper accounting of the financial instruments allows each party to provide information about their financial positions and to make effective economic decisions based on such information. Accounting of the financial instruments may include recognizing the value of the financial instruments according to fair value or amortized cost.

Existing accounting methods of the financial instruments are limited in that they are tailored for specific types of accounting regulations. For example, an accounting method of financial instruments may be limited to only the International Financial Reporting Standards (IFRS), United States Generally Accepted Accounting Principles (US GAAP), or any accounting regulations. The different types of available regulations and constantly changing regulations create a need for accounting methods that can work with different accounting regulations. These accounting methods should also be able to handle the constant changes that are made to the accounting regulations.

In addition, the accounting of the financial instruments should provide information that is useful to the parties for making business decisions. Thus, the information provided by the accounting of the financial instrument should go beyond just the book value. Accounting methods that provide details about the profit and loss statements or other comprehensive income allow parties to make better business decisions. In addition, the accounting of the financial instrument is to reflect those balances which are managed or controlled by the transactional system.

Parties can also make better business decisions if the accounting methods can be utilized with double-entry bookkeeping systems, where the full value of each financial instrument is recorded on the debit side of one or more accounts and on the credit side of one or more accounts.

### BRIEF DESCRIPTION OF THE DRAWINGS

The accompanying drawings illustrate the various embodiments and, together with the description, further serve to explain the principles of the embodiments and to enable one skilled in the pertinent art to make and use the embodiments.

FIG. 1 illustrates the generic distinctions of position components according to an embodiment of the present disclosure.

FIG. 2 illustrates the relationship of the book value components according to an embodiment of the present disclosure.

FIG. 3 illustrates an accounting method that may be associated with the generic distinctions of the position components according to an embodiment of the present disclosure.

FIG. 4 illustrates an accounting method that may be associated with the generic distinctions of the position components according to another embodiment of the present disclosure.

FIG. 5 is a block diagram of an exemplary computer system that may be used with the embodiments of the present disclosure.

### DETAILED DESCRIPTION

Embodiments of the present disclosure provide systems and methods for accounting of financial instruments. The accounting method for financial instrument may include receiving financial instrument data and classifying the financial instrument data into position components. The financial instrument data may be classified into position components based on three distinctions. The first distinction may determine whether the position component is operational or analytical. The second distinction may determine whether the position component is dependent or independent on a value-date. The third distinction may determine whether the position component is event-driven, deterministic or stochastic. The financial instrument accounting may be performed using the financial instrument data classified into the position components.

The embodiments of the methods may be a computer implemented method or may be implemented on a computer system utilizing SAP® HANA database, but is not so limited.

The embodiments of the present disclosure provide an accounting of financial instruments with three generic distinctions. These generic distinctions result in a structuring of the position components that work for all accounting regulations, correctly account for complex dependencies between the different position components and allows for the position components to be grouped into the so-called book value depending on the requirements of the respective accounting regulation. The embodiments of the accounting process utilizing the position components classified according to these generic distinctions allows for all of the position components to be maintained up-to-date based on time and other dependences.

Accounting of financial products (e.g., financial instruments) may be performed by representing a financial position by utilizing a plurality of position components. The financial position may be a financial product (e.g., stock, floating security or fixed-interest bond) that is part of a financial account (e.g., securities account) or any financial contract (e.g. loan, current account). The position components may define and/or describe characteristics of the financial position. The position components may be defined such that they meet generally accepted accounting objectives regarding the information need, the need to be reconciled with the product system at all times, and the form of documentation. The position components may be defined such that they are not limited to any particular accounting regulation (e.g., International Financial Reporting Standards (IFRS) or United States Generally Accepted Accounting Principles (US GAAP)) or to an ad-hoc accounting arrangement. Financial instrument inventory data may be classified into the position components based on the characteristics of the data.

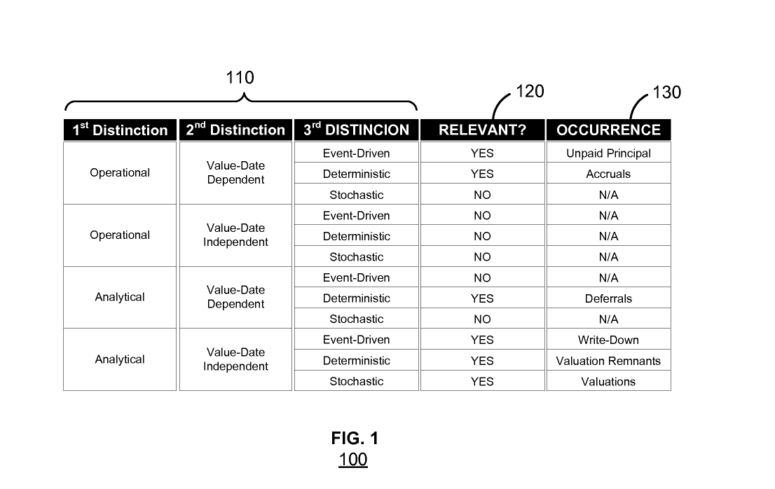

Three simple and generic distinctions may be used to sufficiently capture the relevant aspects and complexities of the accounting. FIG. 1 illustrates the generic distinctions 110 of position components according to an embodiment of the present disclosure. The three generic distinctions 110 may include (1) operational versus analytical, (2) dependence on the value-date, and (3) dependence on what drives the dynamics or time dependence. Financial instrument inventory data may be classified into the position components having these distinctions.

In the first distinction, a position component may be defined as operational if the position component is either managed or controlled by a product system. The product system for, say, a mortgage loan is in charge of processing the loan contracts. This may involve keeping track of due dates and processing customer payments. In the case of an exchange-traded security, the product system may be the trading system. Book value components that are operational may be used for reconciliations. Book value components that are operational may be required to have the same balance in all accounting regulations. A position component may be defined as analytical if it reflects the value-adding tasks of accounting. Book value components that are analytical may generally depend on the type of accounting regulation.

The second distinction determines whether there is dependence on the value-date. The value-date is the date that an entry to a financial account is legally effective or when a transaction is settled. In addition, the value-date is used for the periodic allocation of interest payments, charges and discounts. While other dates, such as the posting date, are relevant for all position components, the value-date may not be a relevant characteristic for all of the position components.

The third distinction may include whether the position component is event-driven, deterministic or stochastic. These distinctions may determine what drives the dynamics or time dependence of the position components. Position components that are event-driven may change in response to real world events. Position components that are deterministic may change based on predefined time dependence. Position components that are stochastic may change erratically due to, for example, the existence of fluctuating risk factors.

As shown in FIG. 1, the three generic distinctions 110 provide for twelve possible combinations. However, some of the combinations may be removed (e.g., classified as being not relevant) because they provide for impossible combinations. For example, a position component that is operational and value-date dependent cannot also be stochastic because stochastic position components cannot be operational or value-date dependent. For the same reasons, other stochastic position components that are either operational or value-date dependent can be removed. In addition, all combinations that are both operational and not value-date dependent can be removed because operational position components are value-date dependent. Another combination that can be removed is for position components which are analytical, value-date dependent and event-driven because analytical and event-driven position components cannot also be value-date dependent.

Based on determination of possible combination the relevance 120 of the combination may be labeled, as shown in FIG. 1. These remaining relevant combinations may be used to sufficiently capture the relevant aspects and complexities of the accounting. Each of the relevant combinations corresponds to a particular type of book value components, which may include more than one book value component.

The possible occurrence 130 of the relevant combination is shown in FIG. 1. The combination of operational, value-date dependent and event driven position components may include unpaid principal balance. The combination of operational, value-date dependent and deterministic position components may include accruals. The combination of analytical, value-date dependent and deterministic position component may include deferrals. The combination of analytical, value-date independent and event-driven position components may include write downs. The combination of analytical, value-date independent and deterministic position components may include valuation remnants. The combination of analytical, value-date independent and stochastic position components may include various valuations (e.g., credit risks, hedged risks and other risks).

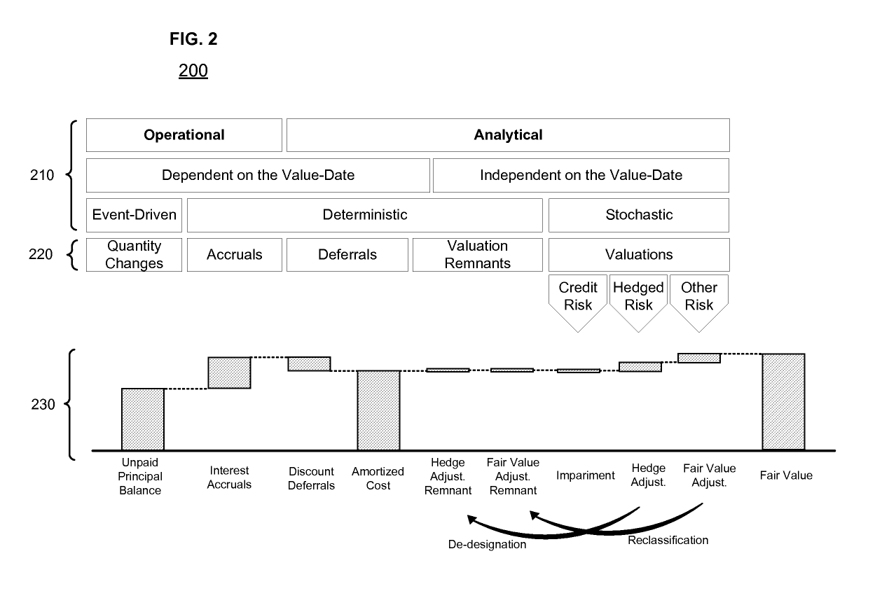

FIG. 2 illustrates the relationship 200 of the book value components according to an embodiment of the present disclosure. The relationship of the position components is based on the distinctions 210 discussed above with reference to FIG. 1. The possible combinations of the distinctions 210 may be associated with particular instances of position components 220. The position components 220 may be used to obtain the value (e.g., fair value or amortized cost) of the financial position. The instances of position components 220 may include quantity changes (e.g., unpaid principal balance), accruals, deferrals, valuation remnants, and valuations (e.g., credit risk, hedged risk and/or other risks). As shown in FIG. 2, each one of the position components 220 correspond to a particular combination of the predetermined distinctions 210. The position components 220 may include a set of position components 220 for each of the possible combinations of the distinctions 210 and each of the position components (e.g., valuations) may include a set of sub-combinations (e.g., credit risk, hedged risk and other risks).

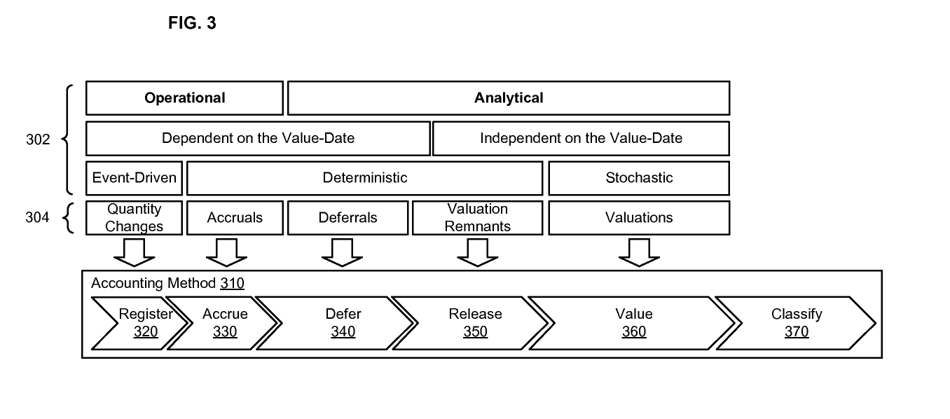

FIG. 2 does not illustrate, but may include, the possible combination of analytical, value-date independent and event-driven position components which relate to the write down component. The combination providing the instance of the write down component will be discussed in more detail with reference to FIG. 3.

FIG. 2 also illustrates examples of position components values 230 that may be part of the position components 220. The position components values 230 may be used to obtain the calculated value (e.g., fair value or amortized cost) of the financial product. Each of the position components values 230 may either add to or subtract from the calculated value. FIG. 2 illustrates examples of the position components 220 and the values 230 associated with the instances of position components 220 and should not be limited to the position components 220 or values 230 illustrated. Other position components may include in-transit accounts, short-term receivables, offset accounts, and currency positions.

The value of position components 230 may be calculated based on the financial instrument inventory data classified into the respective position component 220. The overall valuation of the one or more financial instruments may be obtained by combining the value of position components 230 from left to right. As shown in FIG. 2, the value of each position component 230 is added or subtracted from the preceding summation of the position components. In addition to the final value of the one or more financial instruments, the value of each position component 230 may be used to make business decisions.

Because the position components 220 are broken down based on distinctions 210 which are generic, the calculation may be performed for any accounting regulation. In performing the calculation, one or more of the position components 220 may affect the value of a preceding position component 220. For example, the position component encapsulating the hedged risk may affect the value of the hedge adjustment remnant due to de-designation. Similarly, the fair value adjustment may affect the fair value adjustment remnant due to reclassification.

The arrangements of the position components 220 based on the distinctions 210 allows for reconciliation to take place on the basis of the operational position components. Reconciliation based on the operational position components may be used to ensure correct values are reflected in the accounting system. In addition, the arrangements of the position components 220 provides for double-entry bookkeeping to be performed. With double-entry bookkeeping every contribution to one specific position component may involve an offsetting contribution to either another position component or a profit and loss component. The double-entry bookkeeping with these position components 220 may be used in profit and loss statements or other comprehensive income of a party. For example, accruals arising from payment made at the end of an interest period may correspond to profit and loss statement component ‘unrealized interest income’. In contrast, deferrals arising from payment made in advance may correspond to profit and loss statement component ‘realized interest income.’ The arrangement of the position components 220 also allows for detailed profit and loss statements or other comprehensive income statements. The statements may distinguish between realized interest income, unrealized interest income and one or more valuation results.

FIG. 3 illustrates an accounting method 310 that may be associated with the generic distinctions 302 of the position components 304 according to an embodiment of the present disclosure. The method 310 may include registering 320, accruing 330, deferring 340, releasing 350, valuing 360 and classifying 370. Each of the position components 304 may be processed by the respective steps 320-360 of the accounting method. The accounting method 310 allows for the position components 304 to be constantly updated. The steps of the accounting method 310 may use data associated with the financial instrument to perform the steps. The data can be classified into the position components 304 based on the generic distinctions.

The possible combinations of the distinctions 302 may be associated with particular position components 304. The position components 304 may be used in the steps of the accounting method 310. The position components 304 may include quantity changes, accruals, deferrals, valuation remnants, and valuations (e.g., credit risk, hedged risk and/or other risks). Each of the position components 304 may correspond to a particular combination of the predetermined distinctions 302. As shown in FIG. 3, each of the position components 304 may be associated with a step of the accounting method.

The registering step 320 may be associated with the quantity changes position component. The registering 320 may receive operational information associated with the financial position and calculate or record the quantity changes. The registering 320 may be performed before the other steps to keep the accounting application simple and tractable. The registering step 320 may include processing the business transactions, processing master data changes (e.g., contractual changes) and/or processing credit events. The business transaction may be a customer payment or information on a contractually due payment, a so-called settlement business transaction. Master data changes may include a contractual change (e.g., a restructuring of the contractual payments) or a change in business partner attributes (e.g., a change of the place of residence from “domestic” to “foreign”). Credit events may include an indicator of financial distress (such as a deterioration of the credit rating or the fact that a certain critical dunning level has been reached).

Accruing 330 may be associated with the accruals position component (e.g., interest accruals). The accruing 330 may include calculating the interest accruals associated with the financial position. The deferring 340 may be associated with the deferrals position component. The deferring 340 may include calculating the discount deferral or the periodic charges associated with the financial position. Because the accruals and deferrals position components are dependent on the value-date the accruing 330 and deferring 340 may be performed based on the value-date. The accruing 330 and deferring 340 may be performed after all of the other operational position components are processed.

Releasing 350 may be associated with the valuation remnants position components. The valuation remnants may include hedge adjustment remnant and/or fair value adjustment remnant. The releasing 350 may include releasing valuation remnants to the profit and loss or corresponding reserves.

Valuing 360 may be associated with the valuations position components. The valuing 360 may include determining the value of financial positions and/or processing changes in the valuation methodology. Determining the value of financial positions may include calculating one or more of the credit risk, hedge risk and other risks. These risks may provide for the impairment of the financial position, hedge adjustment of the financial position and/or adjustment to the fair value of the financial position.

Classifying 370 may include determining the relevant disclosure of a position in the financial statements. Classifying 370 may include representing (e.g., as shown in FIG. 2 or in a spreadsheet) the information created in the one or more preceding steps 320-360.

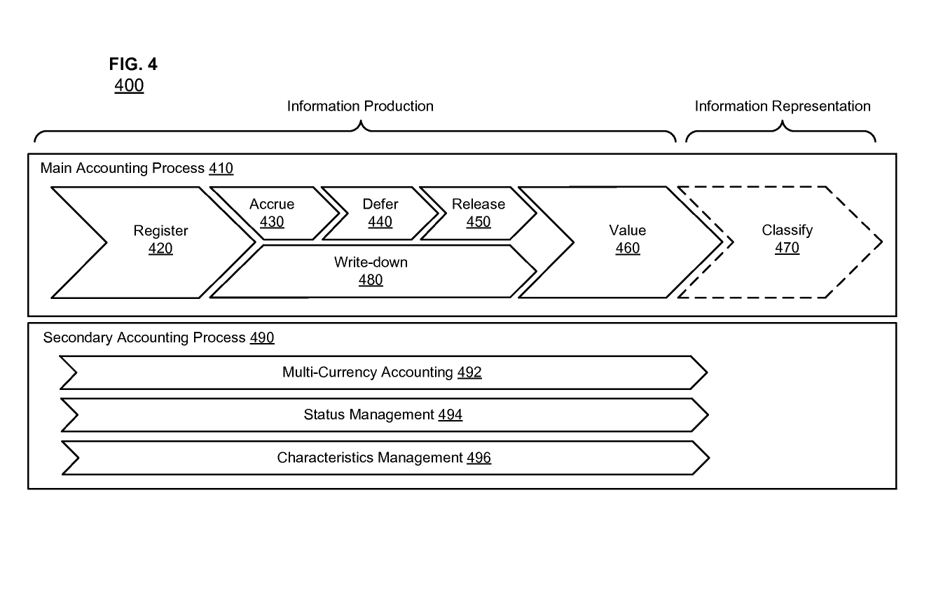

FIG. 4 illustrates an accounting method 400 that may be associated with the generic distinctions of the position components according to another embodiment of the present disclosure. The accounting method 400 may include a main accounting process 410 and a secondary accounting process 490.

The main accounting process 410 may include registering 420, accruing 430, deferring 440, releasing 450, valuing 460, classifying 470 and writing down 480 the data associated with the position components. Each of the position components may be processed by the respective steps 420-480 of the accounting method. Steps 420-470 may correspond to steps 320-370 discussed above with reference to FIG. 3, respectively.

The embodiment shown in FIG. 4 also includes the write down 480 which may correspond to the write down position components. The generic distinctions of the write down component may include analytical, value-date independent and event-driven distinctions.

The secondary accounting process 490 may include processing steps associated with additional position components. The secondary accounting process 490 may perform operations to deal with multiple currencies and keep track of status and characteristics of the financial positions. The secondary accounting process 490 may include one or more of multi-currency accounting 492, status management 494 and characteristics management 496. The multi-currency accounting 492 may include, for example, currency translations into the functional currency, a local currency or the contracts currency, and the recording and valuation of foreign currency exposures. The status management 494 may include keeping track of information on (1) how a given financial instrument is to be valued and classified (e.g., by deriving and maintaining the so-called holding category in IFRS), (2) whether or not a loan has been placed on nonaccruing status, or (3) whether or not a loan requires impairment treatment. The characteristics management may include keeping track of master data relevant to address reporting needs.

In one embodiment, the steps of the secondary accounting process 490 may be performed in parallel with one or more of the steps in the main accounting process 410. In another embodiment, the steps of the secondary accounting process 490 may be performed before or after steps 420-460 and 480 of the main accounting process 410. The classifying 470 may be performed based on the information provided by the steps 420-460 and 480 of the main accounting process and/or the steps 492-496 of the secondary accounting process 490.

Classifying 470 may include assigning the results to a distinct location in the financial statements. Classifying 470 may include displaying the results of the accounting on a user interface and/or providing the results to a results data layer. The results may be provided automatically at predetermined intervals of time or at the occurrence of specific events (e.g., changes in the industry) or the results may be provided in response to a request by a user. Classifying 470 may include grouping a subset of the position components into a book value that is dependent on certain requirements of a specific accounting regulation.

The user interface may also be used to provide data associated with the financial instrument. The data may be manually entered by a user or may be retrieved from a source data layer. A system interface (e.g., source data layer) may provide business transaction data to be used for the accounting of the one or more financial instruments. The data (e.g., business transaction data) may be stored on a data storage device until the data is requested by a processor processing the above discussed methods.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

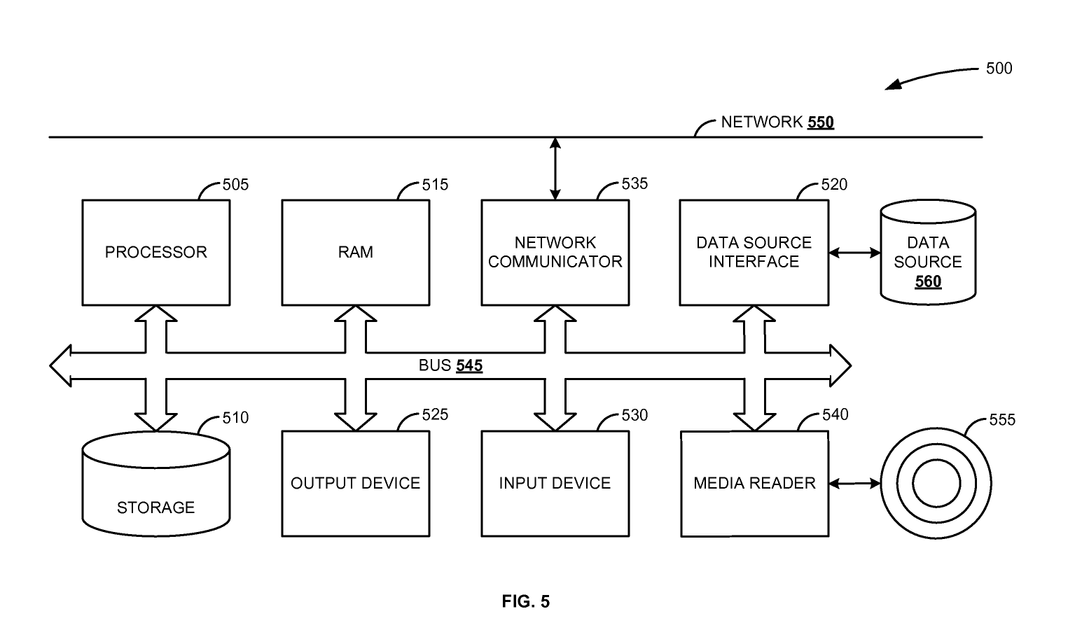

FIG. 5 is a block diagram of an exemplary computer system 500. The computer system 500 includes a processor 505 that executes software instructions or code stored on a computer readable storage medium 555 to perform the above-illustrated methods of the disclosure. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the disclosure, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the various embodiments can be practiced without one or more of the specific details or with other methods, components, techniques, etc. In other instances, well-known operations or structures are not shown or described in detail to avoid obscuring aspects of the disclosure.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments of the disclosure, including what is described in the Abstract, is not intended to be exhaustive or to limit the embodiments to the precise forms disclosed. While specific embodiments of, and examples for, the embodiments are described herein for illustrative purposes, various equivalent modifications are possible within the scope of the disclosure, as those skilled in the relevant art will recognize. These modifications can be made to the embodiments in light of the above detailed description. Rather, the scope of the disclosure is to be determined by the following claims, which are to be interpreted in accordance with established doctrines of claim construction.

We claim:

1. A computer implemented accounting method for financial instrument, comprising:
receiving financial instrument data;
classifying the financial instrument data into position components based on three distinctions, the first distinction determining whether the position component is operational or analytical, the second distinction determining whether the position component is dependent or independent on a value-date, and the third distinction determining whether the position component is event-driven, deterministic or stochastic;
performing financial instrument accounting based on the classified financial instrument data into the position components based on the three distinctions.

2. The computer implemented accounting method of claim 1, further comprising outputting results of the financial instrument accounting to a user interface.

3. The computer implemented accounting method of claim 1, wherein the financial instrument data is received from a user interface or from a system interface.

4. The computer implemented accounting method of claim 1, further comprising discarding position components that are classified as being:
operational, value-date dependent and stochastic;
operational and value-date independent;
analytical, value-date dependent and event-driven; or
analytical, value-date dependent and stochastic.

5. The computer implemented accounting method of claim 1, wherein classifying the financial data into position components includes:
classifying the financial data as the quantity changes position component if the financial data is operational, dependent on the value-date and event driven;
classifying the financial data as the accruals position component if the financial data is operational, dependent on the value-date and deterministic;
classifying the financial data as the deferrals position component if the financial data is analytical, dependent on the value-date and deterministic;
classifying the financial data as the valuation remnants position component if the financial data is analytical, independent on the value-date and deterministic;
classifying the financial data as the valuations position component if the financial data is analytical, independent of the value-date and stochastic; and
classifying the financial data as the write-downs position component if the financial data is analytical, independent on the value-date and event-driven.

6. The computer implemented accounting method of claim 5, wherein valuations position components may correspond to credit risk, hedged risks, or other risk factors.

7. The computer implemented accounting method of claim 5, wherein performing financial instrument accounting includes:
registering one or more position components classified as quantity changes position component;
accruing one or more position components classified as accruals position component;
deferring one or more position components classified as deferrals position component;
releasing one or more position components classified as valuation remnants position component;
valuing one or more position components classified as valuations position component; and
writing down one or more position components classified as write downs position component.

8. The computer implemented accounting method of claim 1, wherein the classified financial instrument data includes: unpaid principal balance, accruals, discount deferrals, write-down amount, hedge adjustment remnant, fair value adjustment remnant, impairment, hedge adjustment and fair value adjustment.

9. The computer implemented accounting method of claim 1, wherein performing financial instrument accounting includes performing multi-currency accounting, performing status management, and performing characteristics management.

10. The computer implemented accounting method of claim 1, wherein performing financial instrument accounting is performed based on International Financial Reporting Standards, United States Generally Accepted Accounting Principles (US GAAP), or other accounting regulation.

11. A computer system for accounting for a financial instrument, comprising:
a data storage device storing data related to the position components of the financial instrument; and
a processor in communication with the data storage device, the processor configured to obtain a value of the financial instrument by:
classifying the data into one of quantity changes, accruals, deferrals, valuation remnants, valuations and write-downs of the financial instrument,
registering one or more position components classified as quantity changes of the financial instrument,
accruing one or more position components classified as accruals of the financial instrument,
deferring one or more position components classified as deferrals of the financial instrument,
releasing one or more position components classified as valuation remnants of the financial instrument,
valuing one or more position components classified as valuations of the financial instrument, and
writing down one or more position components classified as write downs of the financial instrument.

12. The computer system of claim 11, wherein the processor is further configured to classify the processed position components to determine the relevant positions in financial statements comprising a balance sheet including reserves, a profit and loss statement, and notes.

13. The computer system of claim 11, wherein classifying the position components comprises:
classifying the data based on three distinctions into position components, the first distinction determining whether the data is operational or analytical, the second distinction determining whether the data is dependent or independent on a value-date, and the third distinction determining whether the data is event-driven, deterministic or stochastic.

14. The computer system of claim 13, wherein classifying the position components comprises:
classifying the data as the quantity changes if the data is operational, dependent on the value-date and event driven;
classifying the data as the accruals if the data is operational, dependent on the value-date and deterministic;
classifying the data as the deferrals if the data is analytical, dependent on the value-date and deterministic;
classifying the data as the valuation remnants if the data is analytical, independent on the value-date and deterministic;
classifying the data as the valuations if the data is analytical, independent of the value-date and stochastic; and
classifying the data as the write-downs if the data is analytical, independent on the value-date and event-driven.

15. The computer system of claim 11, wherein the valuations may correspond to credit risks, hedged risks, or other risk factors.

16. The computer system of claim 11, wherein the value of the financial instrument includes fair value, amortized cost, or other notion of book value.

17. The computer system of claim 11, wherein obtaining the value of the financial instrument includes performing multi-currency accounting.

18. The computer system of claim 11, wherein obtaining the value of the financial instrument includes performing status management.

19. The computer system of claim 11, wherein obtaining the value of the financial instrument includes performing characteristics management.

20. An accounting system to perform valuation of a financial instrument based on position components of the financial instrument, comprising:
a processor configured to perform financial instrument valuation based on the position components of the financial instrument;
a memory coupled to the processor and configured to store instructions accessed by the processor to perform the financial instrument valuation; and
a user interface configured to obtain data associated with the financial instrument and to display results of the financial instrument valuation data,
wherein the data associated with the financial instrument is classified into one of six position components based on three distinctions, the first distinction determining whether the position component is operational or analytical, the second distinction determining whether the position component is dependent or independent on a value-date, and the third distinction determining whether the position component is event-driven, deterministic or stochastic, and
wherein the instructions for the financial instrument valuation include:
registering one or more position components classified as being operational, dependent on the value-date and event driven,
accruing one or more position components classified as being operational, dependent on the value-date and deterministic,
deferring one or more position components classified as being analytical, dependent on the value-date and deterministic,
releasing one or more position components classified as being analytical, independent on the value-date and deterministic,
valuing one or more position components classified as being analytical, independent on the value-date and stochastic,
writing down one or more position components classified as being analytical, independent on the value-date and event-driven, and
classifying results by assigning them to a distinct location in financial statements.
